(19) United States
(12) Patent Application Publication
(10) Pub. No.: US 2008/0208637 A1
(43) Pub. Date: Aug. 28, 2008

(54) Method And System For Assessing Environmental Risk Associated With Parcel Of Real Property

(75) Inventors: Stephen McKay, Jersey City, NJ (US); Duncan Spencer, Battle (GB)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: American International Group, Inc., New York, NY (US)

(21) Appl. No.: 11/968,923

(22) Filed: Jan. 3, 2008

Related U.S. Application Data
(60) Provisional application No. 60/883,241, filed on Jan. 3, 2007.

(51) Int. Cl. G06Q 40/00

(52) U.S. Cl. 705/4

(57) ABSTRACT

Disclosed is a system and method for assessing environmental risk associated with a parcel of real property through the form of reports which can be generated without the significant expense and time delay of a physical site inspection. Also disclosed is a method to facilitate contaminated land transactions by reports that provide consultancy, legal, and/or financial advice based on factors determined in the absence of a property site visit. In one aspect, the disclosed method comprises several steps based on certain determinations made using commercially-available and publicly-available databases. In another aspect, the disclosed method is a way of providing financial assurance via an insurance policy with the steps of supplying an environmental risk report and automatically supplying an environmental insurance quote based upon the environmental risk report.

### CROSS-REFERENCE TO RELATED APPLICATIONS

This patent application claims the benefit of priority to U.S. Provisional Patent Application No. 60/883,241, filed on Jan. 3, 2007, and entitled “Method and System for Assessing Environmental Risk Associated With Parcel of Real Property,” which is incorporated in its entirety herein by this reference.

### FIELD OF THE INVENTION

This invention pertains to the assessment of environmental risk associated with a parcel of real property, and more particularly to methods and systems for rapidly and economically assessing environmental risk associated with a parcel of real property.

### BACKGROUND OF THE INVENTION

Environmental insurance has been found to help brownfield redevelopment according to the United States Environmental Protection Agency (“EPA”), which provides guidance for EPA brownfield reuse to overcome obstacles that include unanticipated cleanup costs and fears of unforeseen liability that often dissuade otherwise interested developers from investing. Environmental insurance is understood to be a tool capable of limiting these barriers, and can take the form of several different types of policy terms and types of coverage. Cleanup Cost Cap coverage provides the developer with protection against the possibility that actual cleanup costs exceed original estimates. Pollution Liability Protection covers developers and long-term owners of redeveloped brownfields, up to specified amounts, in the event that users of those properties make claims based on continuing pollution conditions. Secured Creditor policies enable lenders to obtain guaranteed load payments in the event the borrower defaults or any pollution condition causes in some way a loss in collateral value.

U.S. Pat. Nos. 7,050,985 and 6,772,128 disclose nuclear decommissioning insurance financial products and methods. U.S. Published Patent Application No. 2003/0105651 discloses a process for insuring and risk managing the decommissioning and/or abandonment of an oil and gas production facility. U.S. Pat. No. 6,766,322 discloses a real estate disclosure reporting method that includes a property walk-through and owner interview. U.S. Pat. No. 5,680,305 discloses a system and a method for evaluating a business entity's real estate. U.S. Pat. No. 5,419,209 discloses a system and protocol for residential environmental assessment to be used by an inspector in inspecting and sampling suspected contaminants in the property.

Methods are thus continuously needed to provide informed, balanced advice on environmental issues involving parcels of real property. Such advice is needed to assess and interpret environmental risks that may otherwise adversely affect property rights. Such advice preferably reduces exposure to negligence claims for property professionals, enables property purchasers to conduct well-informed property negotiations, and helps to guard buyers from property blight. Thus, a need exists for assisting stakeholders involved with property transactions that require identification of potential environmental risks.

Accordingly, when land is being acquired there is a need to rapidly and economically assess the level of environmental risk associated with the property. Improved means of risk assessment are continuously sought, including ways to reduce costs associated with such assessments. Upon such assessments, suitable environmental insurance can transfer such risks as needed to facilitate contaminated land transactions.

### BRIEF SUMMARY OF THE INVENTION

The invention can provide a system and method for assessing environmental risk associated with a parcel of real property through the use of desk-top research by an environmental consultancy that may be provided in the form of reports which can be generated without the significant expense and time delay of a physical site inspection. An insurance quotation can be automatically generated based on the environmental data included in the environmental risk report.

In one aspect, the invention can provide a method of assessing the environmental risk associated with a property comprising several steps. The steps can include: determining a current use or uses of a property, determining an intended use or uses of the property, determining whether the property will be redeveloped (and if the property is not to be redeveloped then further providing an automatic quote for environmental insurance), determining whether underground storage tanks are present on the property (and if tanks present, then site tanks is excluded from said insurance), determining a water distance to nearest surface water, determining a residential distance to a nearest residential property, and determining an agriculture distance to a nearest agriculture property. The method can include the steps of combining the above determinations, optionally with additional information from regulatory, publicly or commercially-available environmental databases, in order to generate an environmental risk assessment report, wherein said report does not involve a physical inspection of the property and then providing that report to at least one person.

In another embodiment, the invention can provide a method of assessing the environmental risk associated with a property sufficient to warrant risk management, mitigation, or risk transfer. The method steps of this embodiment of the invention can include: determining a current use or uses of a property, determining an intended use or uses of the property, determining whether the property will be redeveloped (and if not to be redeveloped then further providing an automatic quote for environmental insurance), determining an age of the property, determining whether underground storage tanks are present on the property (and if present, then site with said tanks is excluded from said insurance), determining a legal indicator for legal advice (i.e. no-change selling, freehold, buying leasehold, renting leasehold, insolvency, refinancing, takeover, or unknown), determining an approximate cost of any transaction involving the property, and determining a timescale of transaction. The method can also include the steps of combining the above determinations, optionally with additional information from regulatory, publicly or commercially-available environmental databases, to generate an environmental risk assessment report, wherein said report does not involve a physical inspection of the property, and then providing said report to at least one person.

In yet another embodiment, the invention can provide a method of providing financial assurance via an insurance policy comprising the steps of: supplying an environmental risk report to a party interested in a parcel of property, supplying an environmental insurance quote depending on said report, receiving at least one premium payment associated with said insurance quote sufficient to initiate an insurance policy, and paying, according to the insurance policy, actual costs related to identified environmental conditions to said party between a policy inception date and a policy termination date, in order to provide financial assurance to said party interested in said parcel.

In an embodiment of a report generated according to an embodiment of a method of the present invention, the report can be compiled and interpreted by an environmental consultant, such as one that is accredited by an environmental organization, such as the Institute of Environmental Management and Assessment (IEMA), for example. The report can include a summary of the potential risks found from a review of large-scale historical maps (e.g., 1:2,5000). The report can be organized such that it includes a one-page executive summary covering the key findings. The report can include risk management solutions for any material environmental issue. The report can indicate a risk of the site being investigated under any applicable environmental law and the level of risk of direct and/or necessary remedial action under the relevant legislation. The report can include an aerial photograph of the study site and a site plan. The report can include an insurance quotation for the site, covering professional indemnity and/or environmental impairment liability, for example.

Additional features, embodiments, and details of this invention can be obtained from the following detailed description of embodiments of the invention.

### BRIEF DESCRIPTION OF THE APPENDICES

Appendix 1 is a specimen of an environmental report legal user's guide suitable for use with the present invention.

Appendix 2 is a specimen of an environmental report financial user's guide suitable for use with the present invention.

Appendix 3 is a specimen of an environmental report suitable for use with the present invention.

### DETAILED DESCRIPTION OF EMBODIMENTS OF THE INVENTION

In one embodiment of the invention, at least one aspect of that embodiment is the provision of a Financial Report that answers a range of pertinent questions described below. In preparing the report, the method can use a comprehensive range of regulatory and commercially-available data sources and databases that also contain historical land use information dating back to the late 19th Century. The report can identify potential environmental risk existing at a subject site, offer specific advice concerning the environmental risk, and automatically generate at least one quotation for insurance.

Many modern environmental regulations require consideration as part of any real estate appraisal and transaction. These regulations require a method to identify and assist in clean up of land where contamination poses an unacceptable risk to human health and/or the environment. Compliance with such regulations can often be costly and can even outweigh the value of the land property itself. Often such regulations require identification of a party to be responsible for the land, whether a prior owner, a present owner or occupier, or even a future purchaser or creditor. The reports used by at least some of the methods of the instant invention provide assistance in addressing these issues of financial risk. Even local legal guidelines may require that real estate attorneys make such assessments of risk as part of their normal practice, without which such legal advice may be deemed insufficient under local administrative or ethical law.

A report generated according to the present invention can be generated by accessing an online web ordering system or, alternatively, can be ordered by post and/or fax. These reports may also be covered by indemnity insurance. The reports can use known mapping techniques and technology to locate a property and its surrounding area by postcode and address. However, there may be some instances when placing an order, where it may be helpful if a requestor provides a site location plan, plat, or land registry plan to ensure the accurate location of the property. The order form can include a field allowing the user to specify their own reference details. Furthermore, the form can allow the user to specify the current and proposed land use that assists the risk assessment procedure and methods of the instant invention. Other specific information requirements requested within the report ordering process can allow a more accurate assessment to be made of the potential environmental risk. The questions asked in one embodiment of the invention (as well as typically available answers and comments) are tabulated below.

| Questions | Available answers | Comments |
|---|---|---|
| Current use? | 1. Residential including flats | This information will be |
| | 2. Offices | used by the environmental |
| | 3. Commercial, e.g. retail, | risk ranking model to help |
| | warehousing | determine the potential for |
| | 4. Light Industrial, e.g. small scale | contaminative operations at |
| | manufacturing | the site. |
| | 5. Industrial, e.g. large scale | |
| | manufacturing works, engineering | |
| | works etc. | |
| | 6. Open space (undeveloped), e.g. | |
| | Greenfield | |
| | 7. Open space (previously | |
| | developed) | |
| | 8. Mixed Uses, e.g. residential and | |
| | commercial/light industrial usage | |
| Intended Use? | 1. Residential including flats | The insurance model (where |
| | 2. Offices | applicable) can use this |
| | 3. Commercial, e.g. retail, | information. |
| | warehousing | |
| | 4. Light Industrial, e.g. small scale | |
| | manufacturing | |
| | 5. Industrial, e.g. large scale | |
| | manufacturing works, engineering | |
| | works etc. | |
| | 6. Open space (undeveloped), e.g. | |
| | Greenfield | |
| | 7. Open space (previously | |
| | developed) | |
| | 8. Mixed Uses, e.g. residential and | |
| | commercial/light industrial usage | |
| Do you intend to | 1. Yes | Automatic quotes for |
| redevelop the site? | 2. No | environmental insurance |
| | | (where applicable) can be |
| | | made not available for sites |
| | | that are due to be |
| | | redeveloped. |
| Are Underground | 1. Yes | *UST defined as fuel or |
| Storage Tanks | 2. No | chemical storage tanks (and |
| (UST)* present? | 3. Unknown | not septic tanks, soakaways, |
| | | interceptors). |
| | | The presence or absence of |
| | | an UST can be used by the |
| | | environmental risk ranking |
| | | model when assessing the |
| | | environmental risk at the |
| | | site. |
| | | Sites with USTs can be |
| | | excluded from the |
| | | environmental insurance |
| | | policy (where insurance is |
| | | applicable). |
| Distance to nearest | 1. On site | The answers can be used to |
| surface water? | 2. Adjacent | better define the |
| | 3. Less than 50 m | environmental sensitivity for |
| | 4. between 50 and 250 m | the consultancy and |
| | 5. None within 250 m | insurance risk models |
| | | (where applicable). |
| Distance to nearest | 1. On site | The answers can be used to |
| residential | 2. Adjacent | better define the |
| property? | 3. Less than 50 m | environmental sensitivity for |
| | 4. between 50 and 250 m | the consultancy and |
| | 5. None within 250 m | insurance risk models |
| | | (where applicable). |
| Distance to nearest | 1. On site | The answers can be used to |
| agricultural land? | 2. Adjacent | better define the |
| | 3. Less than 50 m | environmental sensitivity for |
| | 4. between 50 and 250 m | the insurance risk model |
| | 5. None within 250 m | (where applicable) |

The process of producing a report need not involve a physical site inspection of the property/site. The process can be based on using one or more databases to prepare the report for a reasonable cost. It is understood that any large environmental database may have minor inconsistencies. If a report is issued as a copy of an already existing report to a party that wishes to rely on it, it typically is not necessary to reassess the Site. Maps can also be obtained from public and commercial databases. These databases can be electronic databases that are accessible via a computer network and/or via the internet, for example. All of the report assessments can be based upon the current and proposed use of the study site as indicated by any client or person ordering the same. If the client does not specify a use, then a site use can be assumed. If this use of the site is incorrect or is changed, it may render the site more sensitive and increase the risk of the site being designated as potentially contaminated land. The more accurate the information that the client is able to provide relating to the site when the report is ordered, the more reliable the risk assessment will be.

In one embodiment, the report is organized into sections including conclusions, aerial photographs, and/or summary of risk factors. The data supporting the report supplied allows consultants to interpret the results. In the report these databases and data sets cover the following areas: Historical Industrial Sites (1:10,000 mapping), Recorded Pollution Incidents, Designated Contaminated Land Registers, Landfills and Selected Waste Sites, Current Land Use, and Environmental Setting. Each data area deals with a specific range of environmental information found within the search radii. If no information is found under a particular search category, then a negative response is logged. Some data sets are also represented on the maps presented within the report. These give a graphical representation of the findings of the report. Each data record has a unique identification number that links it to its map position. Each data record provides the distance and direction from the boundary of the study site of that record. Data may typically be commercially obtained; however, public databases are also easily used for the process of the invention.

In one embodiment, databases relied upon within the report are gathered from a wide range of regulatory and commercially owned data sources. A typical summary of the data that is assessed includes databases such as Historical Land Use, Environment Agency Recorded Pollution Incidents, Sites Determined as ‘Contaminated Land’, Landfill Sites, Environment Agency Waste Sites, Current Industrial Sites Data, Gasoline and Fuel Sites, Groundwater Vulnerability, Soil Leaching Potential Source Protection Zones, Designated Sites, and combinations of data thereof.

In one embodiment, the databases are used to make determinations that are then combined to render at least one report. The combination may be based on using a computer to perform or make at least one of the determinations. The method is based upon the potential for specific industries to have generated residual contamination and for this contamination to remain at a site, or to have migrated to neighboring sites. The system also utilizes specific knowledge of the site (built up through database and map interrogation), such as groundwater vulnerability and information obtained during the ordering of the report. In addition, factors such as the presence of residential properties, surface water features, and sensitive habitats can be used to build up a picture of a site's sensitivity to contamination. Contaminative liability can be assessed using a source-pathway-target approach. A high contaminative risk does not necessarily mean that the study site is “contaminated,” but only that sources of potential contamination exist together with pathways for contaminants to migrate to the study site. The report provides a risk screening assessment of the risks posed using key environmental information which could indicate that the property may be designated as “Contaminated Land” as defined by the Environmental Protection Agency. This assessment is based on the above described database(s). From this combination of determinations a report typically contains a statement (with typical comments) regarding:
(1) Environmental risk (Reported, for example, as “Acceptable Environmental Risk” or “In need of Further Assessment”);
(2) Findings in respect of Banking Security (Reported, for example, as “The site is considered to be suitable for loan security from an environmental risk perspective” or “The site is considered to require further assessment to determine if it is suitable for loan security from an environmental risk perspective);
(3) Findings in respect of Legal Liability (Reported, for example, as “Unlikely to be designated as “Contaminated Land” within the meanings of applicable Environmental Protection Acts or regulations” or “Requires further assessment to determine the risk that the site may be designated as “Contaminated Land” within the meanings of applicable Environmental Protection Acts or regulations”);
(4) Findings in respect of Property Value (Reported, for example, as “Environmental issues are unlikely through enforced remedial action to materially impact the value of the property” or “Environmental issues have been identified that require further assessment in order to determine if they are likely to materially impact the value of the property.”); and
(5) Findings in respect of Property Ownership (Reported, for example, as Low/Moderate/High/Very High).

The Low risk level can be based on determinations indicating that environmental issues are unlikely to materially impact the value of the property. The Moderate risk level can be based on determinations indicating that environmental issues are unlikely to materially impact the value of the property but that some environmental issues have been identified that require consideration in order to ensure that the property value will not change over time. The High risk level can be based on determinations indicating that environmental issues are unlikely to materially impact the value of the property but that some environmental issues have been identified that require action without which the property value will change over time. The Very High risk level can be based on determinations indicating that environmental issues have been identified that require further assessment to determine if they are likely to materially impact the value of the property. Recommendations can be provided in the report, where applicable.

In another embodiment of the invention, a report is also generated to answer a range of pertinent questions, the scope of which is set out in detail below. In preparing the reports, a user of the inventive process can use a comprehensive range of regulatory and private data sources that also contain historical land use information dating back a predetermined amount of time, for example, back to the late 19th Century. The report can include an expert assessment of both the available historical Ordnance Survey mapping at the scale of 1:1,250 (and 1:2,500 in some cases) to a minimum radius of 250 m from the study site boundary, and also of the specified environmental data for the requested site. The report can identify if potential significant environmental risk exists at the subject site to warrant risk management, mitigation or risk transfer. The level of Environmental Risk used within the report can be:
(1) Low Risk (No significant potential ground contaminant sources have been identified at the site in the course of this report being prepared. It is considered unlikely that ground contamination will give rise to a liability for the owner of the site.);
(2) Low to Moderate Risk (Some environmental ground contaminant sources may reside with the site associated with the historical, current and/or proposed use of the property. However it is considered unlikely that ground contamination will give rise to a liability for the owner of the site.);
(3) Moderate Risk (Some environmental ground contaminant sources may reside with the site associated with the historical, current and/or proposed use of the property. It is possible but not certain that ground contamination will give rise to a liability for the owner of the site);
(4) Moderate to High Risk: (Some significant ground contaminant sources may reside with the site associated with the historical current and/or proposed use of the property and combined with highly sensitive local environmental receptors. There is moderate to high potential that ground contamination will give rise to a liability for the owner of the site.); and
(5) High Risk (Some significant ground contaminant sources may reside with the site associated with the historical, current and/or proposed use of the property and combined with highly sensitive local environmental receptors. There is a high potential that ground contamination will give rise to a liability for the owner of the site.)

In another embodiment, the reports may be used to address legal and regulatory concerns stemming from applicable Environmental Protection Acts that in some instances now place liability for contaminated land on the current owner or occupier where a ‘past polluter’ cannot be traced. The reports also address a growing number of instances where a failure to identify environmental risks and to make diligent environmental enquiries has led to successful claims for damages against parties involved in a property transaction. Moreover, since local authorities and other statutory bodies do not yet have the full range of information required to determine risk for all environmental issues, specialist environmental advice is essential for information on historical land use, flooding, subsidence, and risk from toxic substances. The reports can take these concepts a step further by allowing potential risks to be identified prior to acquisition and providing realistic solutions including risk management, mitigation or transfer.

In another embodiment, a report can be generated by accessing an online web ordering system or, alternatively, can be ordered by post and/or fax. These reports may also be covered by indemnity insurance. The reports can use known mapping techniques and technology to locate a property and its surrounding area by postcode and address. However, there may be some instances when placing an order, where it may be helpful if a requester provides a site location plan, plat, or land registry plan to ensure the accurate location of the property. The order form can include a field allowing the user to specify their own reference details. Furthermore, the form can allow the user to specify the current and proposed land use that assists the risk assessment procedure and methods of the instant invention. Other specific information requirements requested within the report ordering process can allow a more accurate assessment to be made of the potential environmental risk. The questions asked in another embodiment of the invention (as well as typically available answers and comments) are tabulated below.

| Questions | Available answers | Comments |
|---|---|---|
| Current use? | 1. Residential including flats | This information will be used by the |
| | 2. Offices | environmental risk ranking model to |
| | 3. Commercial, e.g. retail, | help determine the potential for |
| | warehousing | contaminative operations at the site. |
| | 4. Light Industrial, e.g. small scale | |
| | manufacturing | |
| | 5. Industrial, e.g. large scale | |
| | manufacturing works, engineering | |
| | works etc. | |
| | 6. Open space (undeveloped), e.g. | |
| | Greenfield | |
| | 7. Open space (previously developed) | |
| | 8. Mixed Uses, e.g. residential and | |
| | commercial/light industrial usage | |
| Intended Use? | 1. Residential including flats | Different land uses will typically |
| | 2. Offices | have different sensitivities to the |
| | 3. Commercial, e.g. retail, | presence of contamination. This |
| | warehousing | information is used by consultants |
| | 4. Light Industrial, e.g. small scale | to help determine the risk ranking. |
| | manufacturing | The insurance model also uses this |
| | 5. Industrial, e.g. large scale | information. |
| | manufacturing works, engineering | |
| | works etc. | |
| | 6. Open space (undeveloped), e.g. | |
| | Greenfield | |
| | 7. Open space (previously developed) | |
| | 8. Mixed Uses, e.g. residential and | |
| | commercial/light industrial usage | |
| Do you intend to | 1. Yes | Automatic quotes for environmental |
| redevelop the | 2. No | insurance (where applicable) will |
| site? | | not be available for sites that are |
| | | due to be redeveloped. |
| Age of Property | 1. Pre-1990 | Consultancy solutions will be |
| | 2. 1990-1995 | tailored depending on the age of the |
| | 3. 1995-2000 | property. |
| | 4. 2000-present | |
| | 5. Not yet developed | |
| Are | 1.Yes | *UST defined as fuel or chemical |
| Underground | 2. No | storage tanks (and not septic tanks, |
| Storage Tanks | 3. Unknown | soakaways, interceptors). |
| (UST)* present? | | The presence or absence of an UST |
| | | will be used by the environmental |
| | | risk ranking model when assessing |
| | | the environmental risk at the site. |
| | | Sites with USTs are excluded from |
| | | the environmental insurance policy |
| | | (where insurance is applicable). |
| Nature of the | 1. No change Selling | Legal Solutions can be provided for |
| Deal | 2. Freehold | each scenario. |
| | 3. Buying Leasehold | |
| | 4. Renting Leasehold | |
| | 5. Insolvency | |
| | 6. Refinancing | |
| | 7. Takeover | |
| | 8. Unknown | |
| Approximate | 1. 0-US$500,000 | Used to determine if the presence of |
| cost of | 2. US$500,000-US$1,000,000 | contamination is likely to materially |
| transactions? | 3. US$1,000,000-US$5,000,000 | affect the value of the property. |
| | 4. US$5,000,000-US$10,000,000 | |
| | 5. US$10,000,000 plus | |
| | 6. Unknown | |
| Timescale of | 1. Less than 1 week | Consultancy solutions will be |
| transaction? | 2. 1-2 weeks | tailored depending on the timescale |
| | 3. 2-4 weeks | of the transaction. |
| | 4. Greater than 4 weeks | |
| | 5. Unknown | |

With regard to the generation of the automatic insurance quote, a number of assumptions can be made to allow the quote to be generated at the time of ordering the report. The report can include an application form which includes the answers to the questions asked as part of the web ordering process as well as the assumptions made. Should the client wish to proceed with the insurance option, the client may confirm that the assumptions made are correct. If they are not correct, an amended quotation can be produced.

In an alternate embodiment, the report uses determinations from various commercially- and publicly-available databases. The report can be based on data gathered from at least one data source selected from the group consisting of historical land use databases, environmental agency recorded pollution incident databases, sites determined as contaminated land databases, landfill site databases, environmental agency waste site databases, current industrial sites databases, radioactive substance licenses databases, water industry referrals databases, dangerous substance inventory sites databases, licensed discharge consents databases, petroleum and fuel site databases, dangerous or hazardous sites databases, floodwaters databases, natural subsidence databases, radon affected areas databases, mining databases (including coal, and other mineral substances) groundwater vulnerability databases, soil leaching potential databases, government designated property databases, river quality databases, and databases representing combinations thereof. For example, recorded pollution incident categories may include local environmental agency lists such as shown in the table below.

| Pollution Incident | |
|---|---|
| Category | Description |
| Category 1 (Major) | Persistent effect on water quality, closure of |
| | abstraction point, extensive fish mortality, |
| | excessive breaches of consent conditions, |
| | significant effect on amenity value or conservation |
| Category 2 | Potential or actual effect on water quality, |
| (Significant) | notification to water abstractors, significant fish |
| | mortality, water unfit for stock watering, bed of |
| | watercourse contaminated, reduction in amenity |
| | value |
| Category 3 (Minor) | Low fish mortality, bed of watercourse only |
| | locally contaminated around point of discharge, |
| | minimal impact and amenity only marginally |
| | affected |
| Category 4 | Reported incident, upon investigation no evidence |
| (Unsubstantiated) | can be found of incident having occurred |

The vulnerability to groundwater contamination may typically include consideration of aquifers, which can be classified according to the following table.

| Aquifer Type | Characteristics |
|---|---|
| Major Aquifers | Highly fractured and porous rock such as chalk and |
| | limestone, containing large quantities of water. |
| | Generally very sensitive to contamination |
| Minor Aquifers | Fractured or potentially fractured rocks, not |
| | possessing a high permeability and seldom yielding |
| | water in sufficient quantities for large-scale |
| | abstraction purposes. Can be important for local |
| | water supplies |
| Non-Aquifers | Rocks generally regarded as containing insignificant |
| | quantities of groundwater. Some may yield small |
| | quantities for local water supplies |

In an alternate embodiment, a report can answer a range of standard questions, including:
(a) Is the site suitable for Purchase or Loan Security;
(b) Is there a risk of the site being investigated further by regulatory authorities, either formally or informally, under the EPA; and
(c) What is the risk of “Direct Remedial Action” or “Necessary Remedial Action” under “Relevant Legislation”?
   The report can provide transaction recommendations, such as whether the site is suitable for purchase or loan security or in need of further assessment. The report can indicate whether an insurer considers the site to be suitable for purchase or loan security. This statement can be made on the assumption that the interested party is seeking to purchase or take as a security a “clean” site, i.e., one that does not have any significant contaminated land liabilities. This statement is based on whether the insurers will there is risk of “Direct Remedial Action” or “Necessary Remedial Action” under “Relevant Legislation.”

When the report indicates the possibility of contaminated land, the local authority strategies may take many forms, from causing sites to be investigated when redevelopment applications are made to identifying all potentially contaminated sites in their area and investigating them in turn. All investigated sites can be subject to an initial desk-top review and, depending on the findings, may be followed up by more detailed intrusive investigations. Observations of current practice indicate that not all sites are being formally investigated under certain EPA regulations, but that site owners are offering information (from investigations) informally to avoid regulatory “identification” and associated stigma that may affect site value. Therefore, the report can state the risk of investigation as “formal or informal.” It should be noted that a site may be investigated further but that this investigation is limited to the desk-top phase due to an absence of any potential plausible “source-pathway-receptor” relationships. Therefore, if the stated use of the site and surrounding sites remains unchanged, the site is unlikely to present a significant liability.

The following table reflects some of the historic land use data, with generic site specific risk and associated contaminant details that may be used as part of a database used in some of the aspects of some of the embodiments of the inventions described above.

| Site Description | General Guidance |
|---|---|
| Aluminum/Plating/Works/Other | These sites can pose a risk of contamination |
| Metal & Machinery | from metal fines and plating compounds as |
| Factories/Works/Depots | well as from cutting oils, grease and petroleum |
| | fuel involved in cutting operations. Depending |
| | upon the standard of past environmental |
| | management they normally present a moderate |
| | risk. |
| Asbestos Works | Asbestos works can present a high risk of |
| | potential contamination, both from the |
| | production of asbestos containing materials |
| | such as asbestos cement, textiles and friction |
| | materials and from metals, inorganic |
| | compounds, solvents, fuels and poly- |
| | chlorinated biphenyls. The highest risks arise |
| | from raw material handling and storage, |
| | manufacturing operations, pipe work and |
| | sumps and on-site waste storage and disposal. |
| Brewery | Old breweries are normally associated with |
| | high oxygen demand in soils and/or |
| | groundwater resulting from past brewing |
| | processes. In addition potential contaminants |
| | include ammonia, fuel oils and asbestos |
| | lagging from old boilers. Such sites are not |
| | normally regarded ‘high risk’, but some |
| | moderate contamination can often remain. |
| Brickfield/Brickyard | Such sites are normally associated with |
| | infilling however sometimes elevated |
| | concentrations of some heavy metals such as |
| | arsenic may remain. |
| Chalk/Clay/Cement/ | These types of operations present a risk not |
| Concrete/Mortar Works/Mills/Pits | only from the infilling of worked area with |
| Mills | potentially contaminated spoil, but also |
| | because compounds such as benzene, dioxane, |
| | ketones and sodium are widely used in cement |
| | production. Problems may also result from the |
| | instability of poorly filled areas. |
| Chemical Works | Chemical works can pose significant |
| | contamination particularly if operated for long |
| | periods of time. Wide ranges of contaminants |
| | are associated with such sites including acids, |
| | alkalis and solvents. Specific contamination |
| | will largely depend on the activities undertaken at |
| | a site. |
| Depot/Goods | These types of site normally pose no more than |
| Yard/Yard/Warehouses/ | a moderate risk, depending upon the types of |
| Workshops | material stored at the site and number of on site |
| | refueling facilities. |
| Docks/Wharves | Contaminants associated with docks and |
| | wharves can very greatly depend upon the |
| | nature of cargo operations. Cargo operations |
| | can include coal/coke, petroleum products, |
| | metal ores, timber products, food and animal |
| | products. As such there is potential for |
| | significant on site contamination. |
| Ink/Dye Works | Ink/dye works are normally considered high- |
| | risk sites, due to the wide range of raw |
| | materials, final products and waste materials |
| | that may cause adverse soil and groundwater |
| | conditions. Such materials include dyes, acids, |
| | heavy metals, solvents and poly-aromatic |
| | hydrocarbons. Many such compounds can be |
| | toxic to humans or plants (phytotoxic). The |
| | presence of chemical tanks and baths at such |
| | sites can pose an elevated risk of |
| | contamination. |
| Laundry/Dry Cleaning | The main risk from such sites relates to the use |
| | of solvents, bleaches, surfactants and other |
| | cleaning agents including turpentine, enzymes |
| | and fungicides. Some of these compounds can |
| | be toxic and mobile in soils and groundwater. |
| | The degree of risk associated with such sites is |
| | highly dependent upon the age and size of site. |
| Leather Factory/Works | Contaminants associated with such sites |
| | include pathogens (e.g. anthrax), ammonia, |
| | arsenic, and heavy metals. A wide range of |
| | other potential contaminants can be generated |
| | from raw material, final and intermediate |
| | products. These include phenols, acids and |
| | hydrocarbons. |
| Mills | ‘Mills’ are used to describe a wide variety of |
| | large industrial sites developed at the end of |
| | the nineteenth century. They were largely used |
| | for manufacturing and have the potential to |
| | cause significant contamination depending |
| | upon the exact nature of operations. |
| Motor Engineering and Garages | Garages, particularly if poorly managed, can |
| | cause extensive contamination. Typical |
| | contaminants include oils, petrol, solvents and |
| | metals. |
| Nursery/Vinery | Contaminants associated with such activities |
| | include herbicides and pesticides that may |
| | remain in soils for significant period of time. |
| | If applied over long periods of time, |
| | concentrations of these contaminants can build |
| | up and pose a risk to health. |
| Paint Works | Paint works are normally considered high-risk |
| | sites, due to the wide range of raw materials, |
| | final products and waste materials that can |
| | cause adverse soil and groundwater conditions. |
| | Such materials include metals, solvents, |
| | hydrocarbons, coal tars and acids. Many such |
| | compounds can be toxic to humans or plants |
| | (phytotoxic). |
| Print/Lithography/Engraving | Such sites are normally considered to pose a |
| Works/Factory | high risk and associated contaminants include |
| | alkalis, glues, heavy metals, inks, lubricants, |
| | petroleum hydrocarbons, resins, solvents and |
| | varnishes. |
| Pumping Station/Waterworks/ | Such sites do not usually cause significant |
| Tanks | contamination. Contaminants may include oils |
| | from machinery and these can sometime |
| | contain poly-chlorinated biphenyls. Pathogens |
| | and elevated heavy metal concentrations may |
| | result from leakage of wastewater. |
| Railway Land | Railway lines may sometimes pose a risk due |
| | to the transport of potential contaminants that |
| | may fall onto tracks. Further contamination |
| | may arise through use of herbicides and |
| | pesticides to control weeds and pests. |
| | Operational areas, particularly maintenance, |
| | storage and cleaning sheds, may pose an |
| | increased risk and elevated concentrations of |
| | oils and solvents can be common in these |
| | areas. |
| Sewage Works | The main risk associated with sewage works is |
| | the presence of pathogens although other |
| | contaminative risks relate to oils from |
| | machinery and elevated metal concentrations. |
| Smithy | Smithies or Blacksmiths were normally small |
| | operations, found predominately in rural areas. |
| | They can cause minor localized contamination, |
| | mainly of metals but are not normally |
| | considered high-risk sites. |
| Tanneries | Tanneries may pose a significant risk of |
| | contamination, most notably because of the |
| | risk of bacteria and pathogens (such as anthrax) |
| | remaining on site. Other significant issues |
| | relate to the use of brine, dyes, oils and |
| | solvents during the tanning process. |
| Timber Yards and associated Wood | These sites are normally considered to pose a |
| Working Processes. | high risk depending upon the length of |
| | operations at the site and the standard of on site |
| | management. Contaminants associated with |
| | this former use include preservatives, wood |
| | stains, herbicides and fungicides. |
| Tram Depots and Associated Land | Tram depots, tracks and maintenance areas are |
| | common in urban areas where this mode of |
| | transport was common in the early twentieth |
| | century. Contaminants from such activities can |
| | include oils, solvents, fuel, metals and |
| | preservatives. |
| Textile Operations | Wide ranges of contaminants are associated |
| | with textile operations, which may originate |
| | from raw, intermediate and final materials and |
| | more often from waste products. Typical |
| | contaminants can include acids, arsenic, |
| | benzene, dyes, solvents and resins. |
| Works (unspecified) | Works are used to describe a wide variety of |
| | industrial sites where light to heavy |
| | engineering has taken place. As operations at |
| | these sites have not been documented, it is |
| | difficult to identify specific contaminants that |
| | may result from associated operations. |
| | However, generally, metals, oils and solvents |
| | are common, particularly in operational and |
| | chemical/fuel storage areas. The length of time |
| | the site was operational and the standard of site |
| | management will have a significant impact |
| | upon the risk a specific site may pose. |

In yet another embodiment, the invention can provide a method of providing financial assurance via an insurance policy comprising the steps of supplying an environmental risk report to a party interested in a parcel of property, supplying an environmental insurance quote depending on said report, receiving at least one premium payment associated with said insurance quote sufficient to initiate an insurance policy, and paying, according to the insurance policy, actual costs related to identified environmental conditions to said party between a policy inception date and a policy termination date, in order to provide financial assurance to said party interested in said parcel. As with all reports, advice on asbestos management may also be included.

In another aspect of the invention, a customer helpline can be provided to allow the client who has received a report to have any questions concerning the report answered by one or more of a staff of environmental consultants. The customer helpline can be reached via any suitable means, such as, a toll-free telephone number or e-mail over the internet, for example.

Embodiments of the present invention can employ aspects of the technological arts in that aspects of the methods and systems for assessing the environmental risk associated with a property can be implemented using computer networks, computer readable programs, the internet, telephony, etc. A computer system for assessing the environmental risk associated with a property according to the present invention can include at least one assessment component that operates by performing at least one of the steps of a method of assessing the environmental risk associated with a property according to the present invention using a computer and/or a computer network. For example, the an environmental risk report can be generated with the aid of a computer wherein a prospective insured provides information via a computer network and the internet, including e-mail transmissions, and the use of electronic databases, and computational analyses; etc., in order for at least one parameter used to determine the environmental risk report (such as, current use, intended use, redevelopment status, a water distance, a residential distance, and an agriculture distance, for example) to be determined.

The following example further illustrates the invention but, of course, should not be construed as in any way limiting its scope.

### EXAMPLE

This example demonstrates typical report specifications for designing environmental risk reports. First, the report provides reassurance that all standard data sets and additional data sets are consulted. Such databases include the following: Landfill database, Flooding database, Subsidence database, Radon database, Mining database, Water Abstraction database, Recorded Pollution Incidents database, Potentially Hazardous Sites database, Discharge Consents database, and Land Designations database.

The report provides the area covered, with a four day standard turnaround and expedited services available on request.

A report map provision is made for proving clear identification of features including the following:

Historical Industrial Sites <1950

Historical Industrial Sites >1950

Pollution Incidents

Landfill Sites & Other Waste Facilities

Current Land Use

Natural Hazards

Environmental Setting

The report also provides precise distance to features provided above.

The report provides a statement on the Environmental Risk Rating of the Site, a statement on the sites suitability for Loan or Security, a statement on likely identification of site under applicable EPA laws, a consultant's summary of the risk provided in extractable sound bites of text. The report may also include a concise summary provided by a consultant on the actual/potential risks associated with the study site.

The reports may be further assessed by accredited environmental consultants, who may also review any available aerial photographs. Consultants may help confirm historical land uses especially in areas where historical mapping has been classified due to sensitive land use. Reports also take into consideration current land uses and future land uses. The reports may provide guidance on asbestos management.

Reports may also provide solutions that are categorized as: Legal, Consultancy and Financial. All of which are tailored to the speed of any deal and which can be accessed at any point during the deal.

Any Consultancy and Engineering solutions are generally fixed price quoted. As are third party inquiries such as local authority searches, including the following:

Health, Safety & Environmental Management Systems

Risk Assessments

Heath and Safety Assessments

Asbestos Surveys

Legislative Compliance

Flood Risk Assessment

Remediation Strategy & Design

Any Legal Solutions in the report can be incorporated into the report as required. This is normally prepared in consultation with the Environmental Practice of a law firm. But the general report intention is to provide some best practice advice to property/real estate solicitors or to identify circumstances when Environmental Practice should be engaged. In the absence of an in-house team of Environmental lawyers, the report can direct its reader to an appropriate legal panel that can provide support.

Any Financial Solutions can include the following:

Environmental Liability & Insurance

Brownfield Tax advice

Brownfield Project Finance

The report can also provide an insurance quotation automatically under certain conditions, on request with the report, or at any point during the deal. Insurance cover is generally for a period of one year with options on types of cover (operational and/or historical), limits of cover and the excess level. The option to renew the cover will be available to all policy holders.

A report can contain language limiting reliance and trust in the report. Generally, reliance on the report is permitted for up to one year from the date it was produced.

Such reports should be found to efficiently and economically expedite the environmental risk assessment associated with a piece of property in the absence of a specific physical inspection of that property.

Appendices 1-3 provide further examples of materials suitable for use with the present invention.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A method of assessing the environmental risk associated with a property comprising the following steps:
(a) determining a current use or uses of a property;
(b) determining an intended use or uses of the property;
(c) determining whether the property will be redeveloped, and if not to be redeveloped then further providing an automatic quote for environmental insurance;
(d) determining whether underground storage tanks are present on the property, and if present, then site with said tanks is excluded from said insurance;
(e) determining a water distance to nearest surface water;
(f) determining a residential distance to a nearest residential property;
(g) determining an agriculture distance to a nearest agriculture property;
(h) combining the above determinations of steps (a)-(g) to generate an environmental risk assessment report, wherein said report does not involve a physical inspection of the property;
(i) providing said report to at least one person.

2. The method of claim 1 further comprising the step of requesting an environmental risk report with an order form.

3. The method of claim 2 wherein the order form is available online over the internet.

4. The method of claim 1 wherein said report comprises conclusions, at least one aerial photograph from a publicly available database, and a summary of risk factors.

5. The method of claim 4 wherein the conclusions include at least one of an environmental risk statement, a finding with respect to banking security, a finding with respect to legal liability, and a finding with respect to property value.

6. The method of claim 4 wherein the conclusions include a finding with respect to risk of property ownership on a scale of low/moderate/high/very high levels.

7. The method of claim 6 wherein the low risk level is based on determinations indicating that environmental issues are unlikely to materially impact the value of the property.

8. The method of claim 6 wherein the moderate risk level is based on determinations indicating that environmental issues are unlikely to materially impact the value of the property but that some environmental issues have been identified that require consideration in order to ensure that the property value will not change over time.

9. The method of claim 6 wherein the high risk level is based on determinations indicating that environmental issues are unlikely to materially impact the value of the property but that some environmental issues have been identified that require action without which the property value will change over time.

10. The method of claim 6 wherein the very high risk level is based on determinations indicating that environmental issues have been identified that require further assessment to determine if they are likely to materially impact the value of the property.

11. The method of claim 1 wherein said report is based on data gathered from at least one data source selected from the group consisting of historical land use databases, environmental agency recorded pollution incident databases, sites determined as contaminated land databases, landfill site databases, environmental agency waste site databases, current industrial sites databases, petroleum and fuel site databases, groundwater vulnerability databases, soil leaching potential databases, government designated property databases, and databases representing combinations thereof.

12. The method of claim 1 wherein at least one of steps (a)-(h) is performed with a computer.

13. The method of claim 1 further comprising the step of providing guidance on asbestos management.

14. The method of claim 1 wherein said report includes consultant recommendation to contact local agency and/or perform a physical inspection of the property.

15. The method of claim 1 wherein said report includes legal recommendations to consider as part of property transaction including contract exclusion language, liability amounts, and indemnity language.

16. The method of claim 1 wherein the report includes financial solutions including environmental insurance quotes with conditions and limitations.

17. A method of assessing the environmental risk associated with a property, said method comprising the following steps:
(a) determining a current use or uses of a property;
(b) determining an intended use or uses of the property;
(c) determining whether the property will be redeveloped, and if not to be redeveloped, then further providing an automatic quote for environmental insurance;
(d) determining an age of the property;
(d) determining whether underground storage tanks are present on the property, and if present, then site with said tanks is excluded from said insurance;
(e) determining a legal indicator for legal advice, said indicator selected from the group consisting of no-change selling, freehold, buying leasehold, renting leasehold, insolvency, refinancing, takeover, and unknown;
(f) determining an approximate cost of any transaction involving the property;
(g) determining a timescale of said transaction from step (f);
(h) combining the above determinations of steps (a)-(g) to generate an environmental risk assessment report, wherein said report does not involve a physical inspection of the property;
(i) providing said report to at least one person.

18. The method of claim 17 wherein said report is based on data gathered from at least one data source selected from the group consisting of historical land use databases, environmental agency recorded pollution incident databases, sites determined as contaminated land databases, landfill site databases, environmental agency waste site databases, current industrial sites databases, radioactive substance licenses databases, water industry referrals databases, dangerous substance inventory sites databases, licensed discharge consents databases, petroleum and fuel site databases, dangerous or hazardous sites databases, floodwaters databases, natural subsidence databases, radon affected areas databases, mining databases, groundwater vulnerability databases, soil leaching potential databases, government designated property databases, river quality databases, and databases representing combinations thereof.

19. The method of claim 17 wherein at least one of steps (a)-(h) is performed with a computer.

20. The method of claim 19 wherein at least one of steps (a)-(h) is performed online over the internet.

21. A method of providing financial assurance via an insurance policy comprising the following steps:
(i) supplying an environmental risk report to a party interested in a parcel of property;
(ii) automatically supplying an environmental insurance quote based upon said environmental risk report;
wherein said environmental risk report is generated by:
(a) determining a current use or uses of a property;
(b) determining an intended use or uses of the property;
(c) determining whether the property will be redeveloped, and if the property is to be redeveloped then not supplying an automatic environmental insurance quote;
(d) determining whether underground storage tanks are present on the property, and if present, then site with said tanks is excluded from any automatic insurance quote;
(e) determining a water distance to nearest surface water;
(f) determining a residential distance to a nearest residential property;
(g) determining a agriculture distance to a nearest agriculture property;
(h) combining the above determinations of steps (a)-(g) to generate an environmental risk assessment report, wherein said report does not involve a physical inspection of the property; and
wherein at least one of steps (a)-(h) is performed with a computer.

22. The method of claim 21 wherein said report is based on data gathered from at least one data source selected from the group consisting of historical land use databases, environmental agency recorded pollution incident databases, sites determined as contaminated land databases, landfill site databases, environmental agency waste site databases, current industrial sites databases, petroleum and fuel site databases, groundwater vulnerability databases, soil leaching potential databases, government designated property databases, and databases representing combinations thereof.

23. The method of claim 21, further comprising:
(iii) receiving at least one premium payment associated with said insurance quote sufficient to initiate an insurance policy;
(iv) paying, according to the insurance policy, actual costs related to identified environmental conditions to said party between a policy inception date and a policy termination date, in order to provide financial assurance to said party interested in said parcel.
